(19) United States
(12) Patent Application Publication
(10) Pub. No.: US 2008/0150806 A1
(43) Pub. Date: Jun. 26, 2008

(54) MULTIPLE INPUT MULTIPLE OUTPUT ANTENNA

(75) Inventors: XIANG-HONG QIN, Shenzhen (CN); JIA-LIN TENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/960,710

(22) Filed: Dec. 20, 2007

(30) Foreign Application Priority Data
Dec. 22, 2006 (CN) 200610157877.7

(51) Int. Cl. H01Q 9/04

(52) U.S. Cl. 343/700 MS

(57) ABSTRACT

A MIMO antenna (10) disposed on a substrate (40) including a first surface (42) and a second surface (44). The MIMO antenna includes a first antenna (20) and a second antenna (30) each including a radiating body (26), a grounded body (28), a feeding portion (22) for feeding signals, and a pair of ground planes (24) laid on opposite sides of the feeding portion and electronically connected to the grounded body. The radiating body includes a first radiating portion (260) and a meandering second radiating portion (262) electronically connecting to the first radiating portion. The feeding portion is electronically connected to the second radiating portion. The radiating body, the ground planes, and the feeding portion are printed on the first surface of the substrate, and the grounded body is printed on the second surface of the substrate.

### BACKGROUND

1. Field of the Invention

The present invention relates to antennas, and particularly to a multiple input multiple output (MIMO) antenna.

2. Description of related art

Wireless communication devices, such as mobile phones, wireless cards, and access points, wirelessly radiate signals via electromagnetic waves. Thus, remote wireless communication devices can receive the signals without the need for cables.

In a wireless communication device, the antenna is a key element for radiating and receiving electromagnetic signals. Characteristics of the antenna, such as radiation efficiency, orientation, frequency band, and impedance matching, have a significant influence on performance of the wireless communication device. Nowadays, the number of users continues to increase and data traffic is becoming an increasingly more important part of the wireless communication system. Both of these factors mean that it is important for operators to look for methods of increasing the capacity of their wireless communication systems to meet future demands.

A relatively new wireless communications technology known as multiple input multiple output (MIMO) systems provides for increased system capacity. A number of antennas are used on both the transmitter and receiver, which together with appropriate beam forming and signal processing technologies are capable of providing two or more orthogonal radio propagation channels between the two antennas. The antennas are spaced apart in order to decorrelate the signals associated with adjacent antennas.

There is a need for improved antenna arrangements for use with MIMO systems.

### SUMMARY OF THE INVENTION

An exemplary embodiment of the present invention provides a MIMO antenna disposed on a substrate including a first surface and a second surface. The MIMO antenna includes a first antenna and a second antenna. The first antenna and the second antenna each include a radiating body for transceiving electromagnetic signals, a feeding portion for feeding signals, and a pair of ground planes laid on opposite sides of the feeding portion, a grounded body electronically connected to the pair of ground planes. The radiating body includes a first radiating portion and a meandering second radiating portion electronically connecting to the first radiating portion. The feeding portion is electronically connected to the second radiating portion of the radiating body. The radiating body, the pair of ground planes, and the feeding portion are printed on the first surface of the substrate, and the grounded body is printed on the second surface of the substrate.

Other advantages and novel features will become more apparent from the following detailed description when taken in conjunction with the accompanying drawings, in which:

### BRIEF DESCRIPTION OF THE DRAWINGS

FIG. 1 is a schematic plan view of a multi input multi output (MIMO) antenna of an exemplary embodiment of the present invention, the MIMO antenna includes a first antenna and a second antenna;

FIG. 2 is similar to FIG. 1, but viewed from another aspect;

FIG. 3 is an enlarged view of a circled portion III of FIG. 1;

FIG. 4 is a graph of test results showing a voltage standing wave ratio (VSWR) of the first antenna of FIG.1;

FIG. 5 is a graph of test results showing a VSWR of the second antenna of FIG. 2;

FIG. 6 is a graph of test results showing an isolation of the first antenna relative to the second antenna of FIG. 1; and

FIG. 7 is a graph of test results showing an isolation of the second antenna relative to the first antenna of FIG. 1.

### DETAILED DESCRIPTION OF THE INVENTION

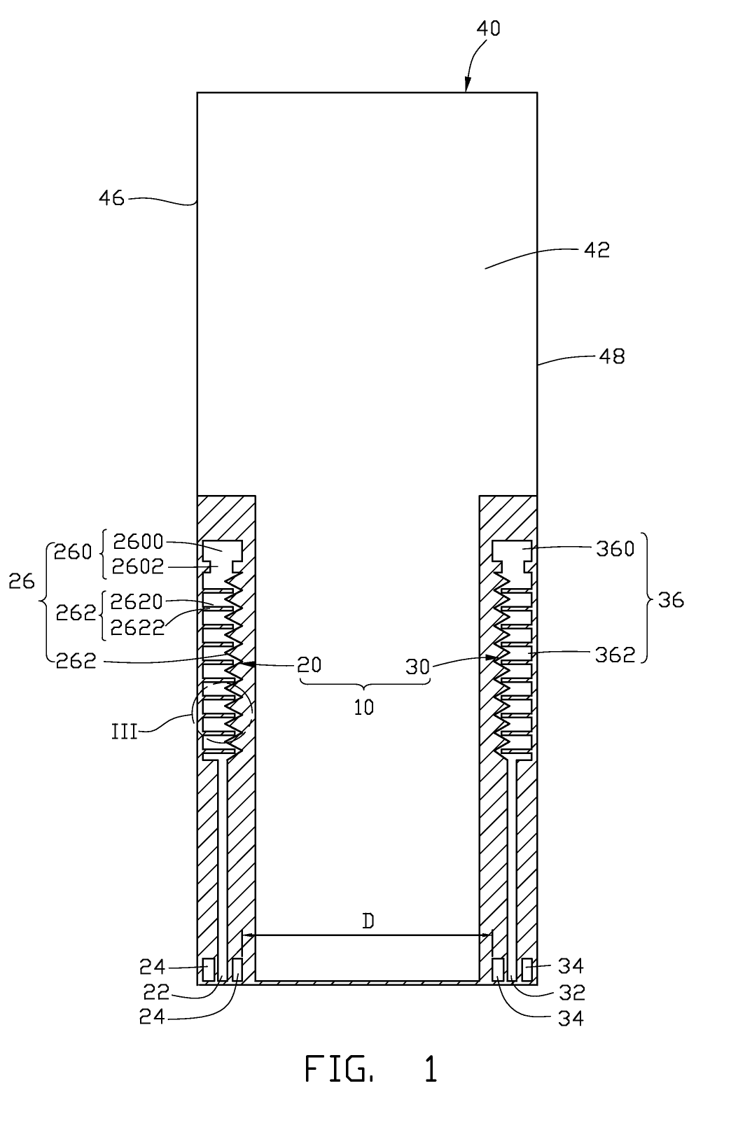

FIG. 1 is a schematic plan view of a multi input multi output (MIMO) antenna 10 of an exemplary embodiment of the present invention. In the exemplary embodiment, the MIMO antenna 10 is printed on a substrate 40.

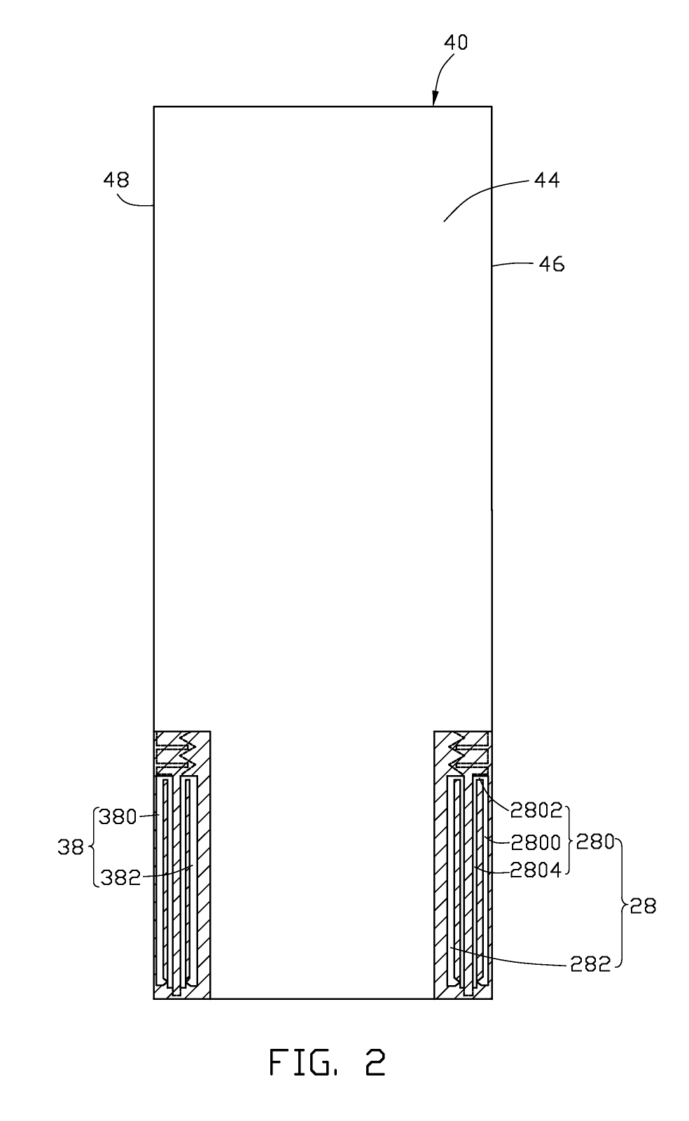

Referring also to FIG. 2, the substrate 40 comprises a first surface 42, a second surface 44 parallel to the first surface 42, a first side 46, and a second side 48 parallel to the first side 46.

The MIMO antenna 10 comprises a first antenna 20 and a second antenna 30. The first antenna 20 and the second antenna 30 are symmetrically disposed on the substrate 40. The first antenna 20 is adjacent to the first side 46 of the substrate 40, and the second antenna 30 is adjacent to the second side 48 of the substrate 40.

The first antenna 20 comprises a radiating body 26, a grounded body 28, a pair of metallic ground planes 24, and a feeding portion 22. The radiating body 26, the ground planes 24, and the feeding portion 22 are printed on the first surface 42 of the substrate 40. The grounded body 28 is printed on the second surface 44 of the substrate 40.

The radiating body 26 is used for transceiving electromagnetic signals. The radiating body 26 comprises a generally T-shaped first radiating portion 260, and a meandering second radiating portion 262 electronically connected to the first radiating portion 260. The first radiating portion 260 comprises a top portion 2600 and a first connecting portion 2602 electronically connecting the top portion 2600 to the second radiating portion 262. The width of the first connecting portion 2602 is less than that of the top portion 2600.

The second radiating portion 262 is electronically connected to the feeding portion 22, and comprises a plurality of rectangular tooth portions 2620 electronically connecting to each other, and a plurality of strip-like gaps 2622 parallel to each other. The gaps 2622 are defined between every two adjacent tooth portions 2620 and extend from a first side of the second radiating portion 262 into the second radiating portion 262. A plurality of triangular indents 264 extend from a second side of the second radiating portion 262 opposite to the first side into the second radiating portion 262. The plurality of indents 264 are arranged to stagger with the plurality of gaps along the lengthwise direction, i.e., the extending direction of the first and/or second side, of the second radiating portion 262.

In an alternative embodiment, the number of the tooth portions 2620 and the gaps 2622 of the second radiating portion 262 can be varied.

In the exemplary embodiment, the first radiating portion 260 improves return loss of the first antenna 20.

In the embodiment, the route of the electromagnetic wave is indirect, allowing precise control over the length of the route followed by the electromagnetic wave. The length of the route of the electromagnetic wave from the first radiating portion 260 to the second radiating portion 262 must be kept to a predetermined length, such as substantially a fourth of the working wavelength of the first antenna 20, and so the route is configured in a switchback pattern. Therefore, relatively speaking, the first antenna 20 of the present invention is configured in a compact manner allowing for use in newer smaller wireless communication devices. That is, the first antenna 20 has a lower profile and a smaller size.

In addition, the first antenna 20 has a better radiation pattern due to the gaps 2622 of the second radiating portion 262.

The feeding portion 22 is electronically connected to and feeds signals to the second radiating portion 262. The feeding portion 22 is generally parallel to the first side 46 of the substrate 40, and is a 50 ohm transmission line.

The ground planes 24 are electronically connected to a ground circuit of the substrate 40 (not shown), and each of the ground planes 24 is rectangular. The ground planes 24 are laid on opposite sides of the feeding portion 22, and are symmetrical about the feeding portion 22.

The grounded body 28 is electronically connected to the pair of ground planes 24. The grounded body 28 comprises a first grounded portion 280 and a second grounded portion 282 arranged abreast of the first grounded portion 280. The first grounded portion 280 comprises a second connecting portion 2800, a third connecting portion 2802, and a fourth connecting portion 2804 parallel to the second connecting portion 2800. The third connecting portion 2802 electronically connects the second connecting portion 2800 to the fourth connecting portion 2804. The second connecting portion 2800 is electronically connected to one of the ground planes 24 through a via (not shown). An end of the fourth connecting portion 2804 is a free end. Configurations of all elements of the second grounded portion 282 and relations among the elements of the second grounded portion 282 are the same as those of the first grounded portion 280.

The second antenna 30 comprises a radiating body 36, a grounded body 38, a pair of metallic ground planes 34, and a feeding portion 32. The radiating body 36 comprises a first radiating portion 360, and a second radiating portion 362 electronically connected to the first radiating portion 360. The grounded body 38 comprises a first grounded portion 380 and a second grounded portion 382 arranged abreast of the first grounded portion 380. Configurations of all elements of the second antenna 30 and relations among the elements of the second antenna 30 are the same as those of the first antenna 20. The radiating body 36, the ground planes 34, and the feeding portion 32 of the second antenna 30 are printed on the first surface 42 of the substrate 40. The grounded body 38 is printed on the second surface 44 of the substrate 40. The second antenna 30 and the first antenna 20 are symmetrically formed with each other, i.e., mirror-shaped with each other relative to an imaginary center line of the first surface 42 of the substrate 40.

In the exemplary embodiment, the length of the first radiating portion 260 is generally 1.5 mm, and the width of the first radiating portion 260 is generally 1.8 mm. The length of the second radiating portion 262 is generally 9.9 mm, and the width of the second radiating portion 262 is generally 1.8 mm. The length of each of the ground planes 24 is generally 1 mm. The length of the feeding portion 22 is generally 10 mm. The length of the second connecting portion 2800 is generally 9.4 mm, and the width of the second connecting portion 2800 is generally 0.3 mm. The length of the third connecting portion 2802 is generally 0.2 mm, and the width of the third connecting portion 2802 is generally 0.2 mm. The length of the fourth connecting portion 2804 is generally 9.5 mm, and the width of the fourth connecting portion 2804 is generally 0.2 mm. The distance between the first antenna 20 and the first side 46 is generally 0.1 mm, and the distance between the second antenna 30 and the second side 48 is generally 0.1 mm. The distance D between the first antenna 20 and the second antenna 30 is generally 11.2 mm. Lengths and widths of all the elements of the second antenna 30 are generally equal to those of the first antenna 20, respectively.

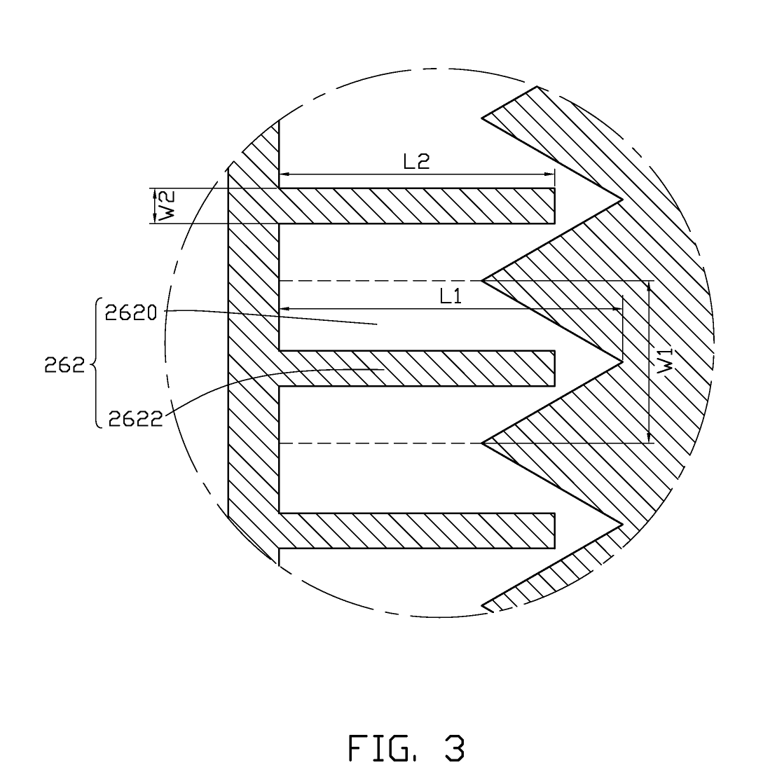

FIG. 3 is an enlarged view of a circled portion III of FIG. 1. In the exemplary embodiment, a length L1 of each of the tooth portions 2620 is generally 1.8 mm, and a width W1 of each of the tooth portions 2620 is generally 0.8 mm. A length L2 of each of the gaps 2622 is generally 1.4 mm, and a width W2 of each of the gaps 2622 is generally 0.2 mm.

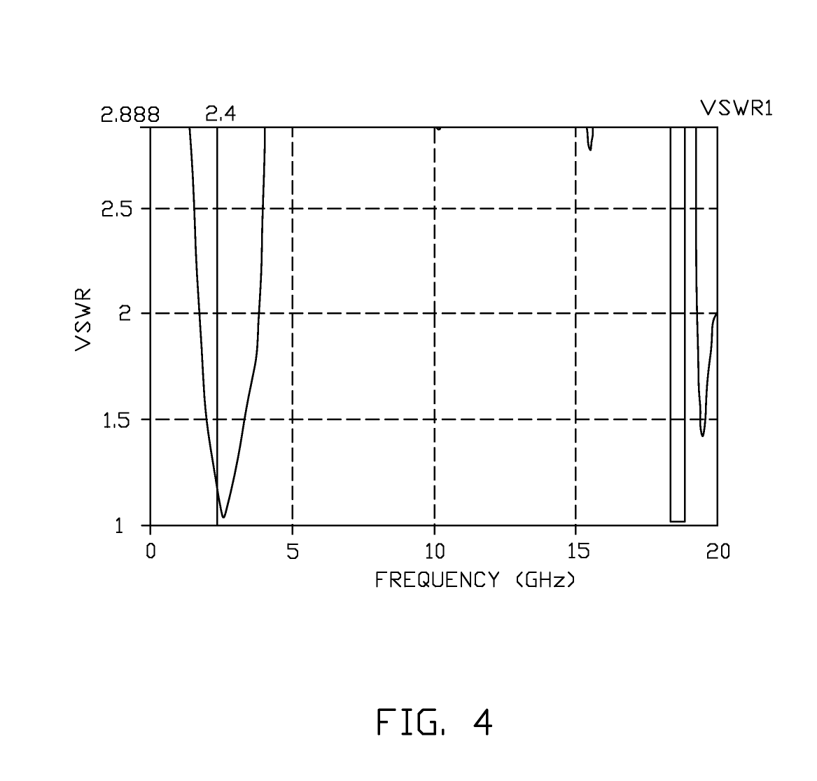

FIG. 4 is a graph of test results showing voltage standing wave ratio (VSWR) of the first antenna 20. The horizontal axis represents the frequency (in GHz) of the electromagnetic signals traveling through the first antenna 20, and the vertical axis represents a VSWR. VSWR of the first antenna 20 over the range of frequencies is indicated by a curve. As shown in FIG. 4, the first antenna 20 performs well when operating at frequencies from 2.4-2.5 GHz. The amplitudes of the VSWRs in the band pass frequency range are less than 2.

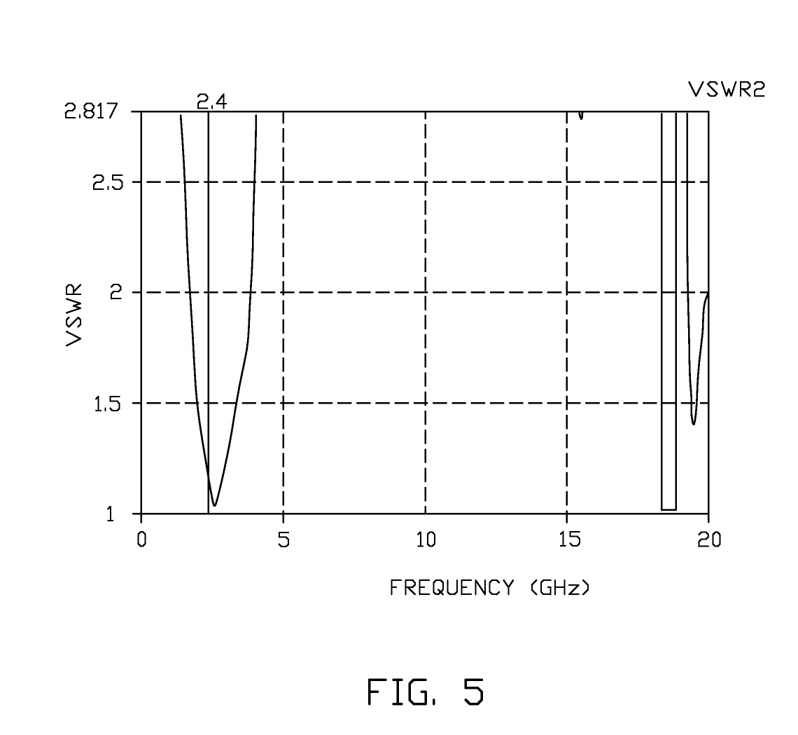

FIG. 5 is a graph of test results showing voltage standing wave ratio (VSWR) of the second antenna 30. The horizontal axis represents the frequency (in GHz) of the electromagnetic signals traveling through the second antenna 30, and the vertical axis represents a VSWR. VSWR of the first antenna 20 over the range of frequencies is indicated by a curve. As shown in FIG. 5, the second antenna 30 performs well when operating at frequencies from 2.4-2.5 GHz. The amplitudes of the VSWRs in the band pass frequency range are also less than 2.

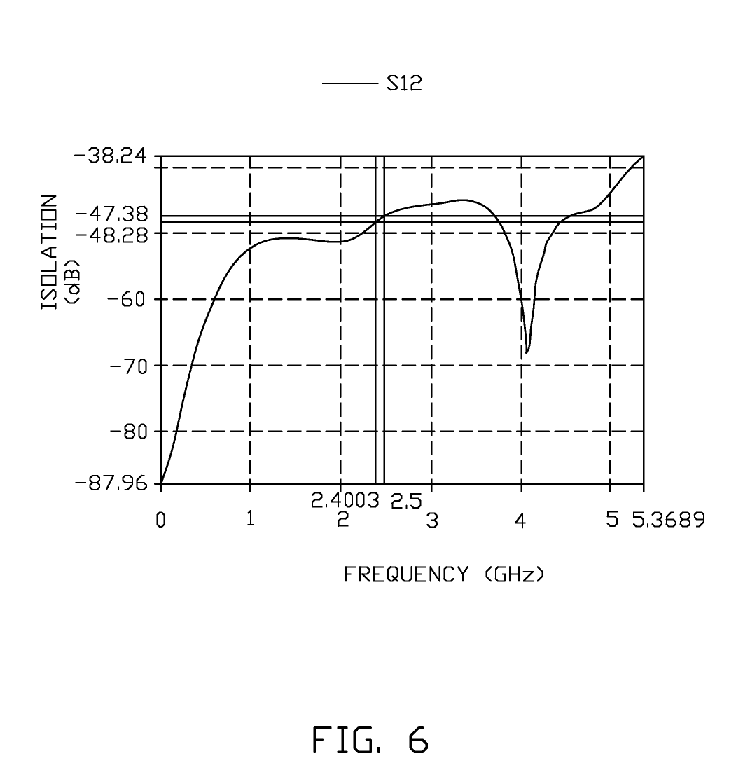

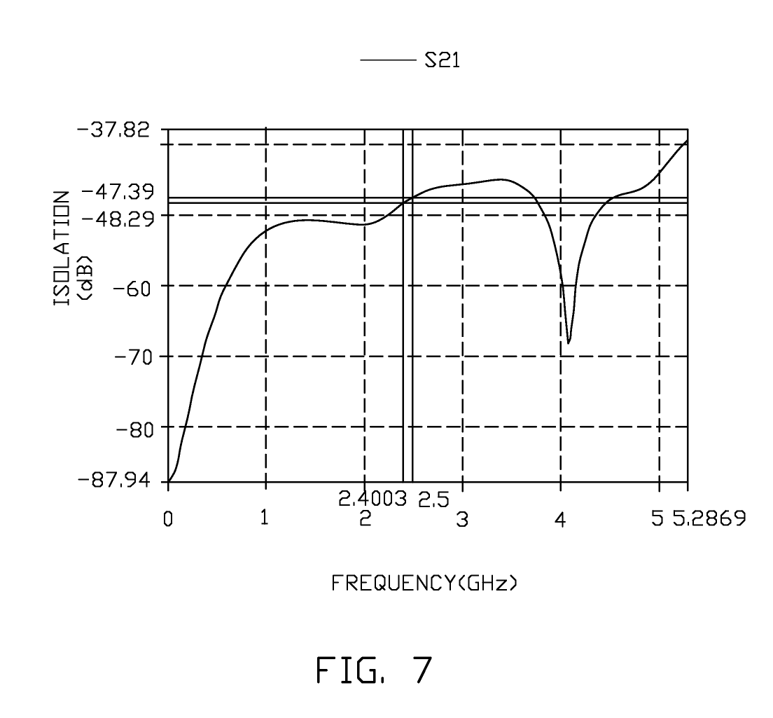

FIG. 6 is a graph of test results showing isolation of the first antenna 20 relative to the second antenna 30 of the MIMO antenna 10. FIG. 7 is a graph of test results showing isolation of the second antenna 30 relative to the first antenna 20 of the MIMO antenna 10. In FIGS. 6-7, the horizontal axis represents the frequency (in GHz) of the electromagnetic signals traveling through the MIMO antenna 10, and the vertical axis indicates amplitude of isolation. A curve represents amplitudes of isolation over the range of frequencies. As shown in FIGS. 6-7, the values of isolation never go higher than approximately −47.39 dB over the range of frequencies, thus isolation between the first antenna 20 and the second antenna 30 is good.

While embodiments of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A multi input multi output (MIMO) antenna printed on a substrate comprising a first surface and a second surface, the MIMO antenna comprising a first antenna and a second antenna, the first antenna and the second antenna each comprising:
a radiating body for transceiving electromagnetic signals, the radiating body comprising a first radiating portion and a meandering second radiating portion electronically connecting to the radiating portion;
a feeding portion for feeding signals, the feeding portion electronically connected to the second radiating portion of the radiating body; and
a pair of ground planes laid on opposite sides of the feeding portion;
a grounded body electronically connected to the pair of ground planes;
wherein, the radiating body, the pair of ground planes, and the feeding portion are printed on the first surface of the substrate, and the grounded body is printed on the second surface of the substrate.

2. The MIMO antenna as claimed in claim 1, wherein the radiating portion is generally T-shaped.

3. The MIMO antenna as claimed in claim 2, wherein the radiating portion comprises a top portion and a first connecting portion electronically connecting the top portion to the second radiating portion.

4. The MIMO antenna as claimed in claim 3, wherein the width of the first connecting portion is less than that of the top portion.

5. The MIMO antenna as claimed in claim 1, wherein the first pair of ground planes are symmetrical about the feeding portion.

6. The MIMO antenna as claimed in claim 1, wherein the second radiating portion comprises a plurality of tooth portions electronically connecting to each other.

7. The MIMO antenna as claimed in claim 6, wherein the second radiating portion comprises a plurality of gaps defined between every two adjacent the tooth portions and parallel to each other.

8. The MIMO antenna as claimed in claim 1, wherein the grounded body comprises a first grounded portion and a second grounded portion arranged abreast of the first grounded portion.

9. The MIMO antenna as claimed in claim 8, wherein the first grounded portion comprises a second connecting portion, a third connecting portion, and a fourth connecting portion parallel to the second connecting portion, an end of the second connecting portion electronically connected to one of the ground planes.

10. The MIMO antenna as claimed in claim 9, wherein configurations of all elements of the second grounded portion and relations among the elements of the second grounded portion are the same as those of the first grounded portion.

11. A multi input multi output (MIMO) antenna disposed on a substrate comprising a first surface and a second surface, the MIMO antenna comprising a first antenna and a second antenna, the first antenna and the second antenna each comprising:
a radiating body for transceiving electromagnetic signals, the radiating body comprising a T-shaped radiating portion and a second radiating portion electronically connecting to the radiating portion;
a feeding portion for feeding signals, the feeding portion electronically connected to the second radiating portion of the radiating body; and
a pair of ground planes laid on opposite sides of the feeding portion;
a grounded body electronically connected to the pair of ground planes, the grounded body comprising a first grounded portion and a second grounded portion arranged abreast of the first grounded portion;
wherein, the radiating body, the feeding portion, and the pair of ground planes are printed on the first surface of the substrate, and the grounded body is printed on the second surface of the substrate.

12. The MIMO antenna as claimed in claim 1, wherein the second radiating portion is meandering.

13. The MIMO antenna as claimed in claim 1, wherein the radiating portion comprises a top portion and a first connecting portion electronically connecting the top portion to the second radiating portion.

14. The MIMO antenna as claimed in claim 13, wherein the width of the first connecting portion is less than that of the top portion.

15. The MIMO antenna as claimed in claim 1, wherein the ground planes are symmetrical about the feeding portion.

16. The MIMO antenna as claimed in claim 11, wherein the second radiating portion comprises a plurality of tooth portions electronically connecting to each other.

17. The MIMO antenna as claimed in claim 16, wherein the second radiating portion comprises a plurality of gaps defined between every two adjacent tooth portions and parallel to each other.

18. The MIMO antenna as claimed in claim 1, wherein configurations of all elements of the second grounded portion and relations among the elements of the second grounded portion are the same as those of the first grounded portion.

19. An antenna assembly comprising:
a substrate; and
an antenna disposed on a surface of said substrate, and comprising a radiating body for transceiving electromagnetic signals and a feeding portion electrically connectable with said radiating body for feeding signals, said radiating body comprising a radiating portion extending therein and defining a first side and a second side opposite to said first side, a plurality of gaps extending from said first side into said radiating portion, and a plurality of indents extending from said second side into said radiating portion, said plurality of gaps staggering with said plurality of indents along an extending direction of said first side.

20. The antenna assembly as claimed in claim 19, further comprising another antenna disposed on said surface of said substrate and spaced from said antenna, said another antenna being shaped symmetrically with said antenna.
